(19) United States
(12) Patent Application Publication
(10) Pub. No.: US 2008/0288348 A1
(43) Pub. Date: Nov. 20, 2008

(54) Ranking online advertisements using retailer and product reputations

(75) Inventors: Huajun Zeng, Beijing (CN); Chenxi Lin, Beijing (CN); Dingyi Han, Shanghai (CN); Benyu Zhang, Beijing (CN); Zheng Chen, Beijing (CN); Jian Wang, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/803,461

(22) Filed: May 15, 2007

(51) Int. Cl. G06Q 30/00

(52) U.S. Cl. 705/14

(57) ABSTRACT

A method for ranking online advertisements using retailer reputation and product reputation. In one implementation, a query may be received. Advertisements may be selected by determining a level of relevance between the query and each advertisement and selecting the advertisements with a level of relevance above a pre-determined level of relevance. A predicted reputation for a retailer and a predicted reputation for a product may be retrieved for each of the selected advertisements. The selected advertisements may then be ranked based on the predicted reputation for the retailer and the predicted reputation of the product. The ranking of the selected advertisements may be accomplished by calculating a ranking score for each selected advertisement based on the retailer predicted reputation and the product predicted reputation. The selected advertisements may then be displayed according to the ranking.

### BACKGROUND

Various websites may offer to display advertisements on their web pages as a source of revenue. Websites may be paid by the advertiser for each click an advertisement receives. Websites may display different advertisements based upon the website user's requests or queries. For example, a search engine website may receive a query and display advertisements above or to the right of search results. Because websites displaying advertisements may increase revenue by increasing the number of clicks on advertisements, many websites may rank advertisements before displaying them. Advertisements may be ranked according to the relevance of each advertisement to a query, the amount of money each advertiser has contracted to pay per click, the estimated click-through rate, or click history, of each advertisement and the like.

### SUMMARY

Described herein are implementations of various techniques for ranking online advertisements using retailer reputation and product reputation. In one implementation, a query may be received and advertisements may be selected based on the query. The advertisements may be selected by determining a level of relevance between the query and each advertisement and selecting the advertisements with a level of relevance above a pre-determined level of relevance. A predicted reputation for a retailer and a predicted reputation for a product may be retrieved for each selected advertisement. The selected advertisements may then be ranked based on the predicted reputation for the retailer and the predicted reputation of the product. The ranking of the selected advertisements may be accomplished by calculating a ranking score for each selected advertisement based on the retailer predicted reputation and the product predicted reputation. The selected advertisements may then be displayed according to the ranking.

Described herein are implementations of various techniques for predicting a reputation for a retailer or a product or both. In one implementation, online reviews of the retailer or the product or both may be collected. A probability of a positive orientation and a probability of a negative orientation for each online review may be determined by comparing each online review to a positive review trigram model and a negative review trigram model. A positive or negative orientation for each online review may be determined by comparing the probability of the positive orientation with the probability of the negative orientation. A predicted reputation of the retailer or the product or both may then be calculated based on a percentage of online reviews with a positive orientation.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a flow diagram of a method for ranking online advertisements using predicted retailer reputations and predicted product reputations in accordance with implementations of various techniques described herein.

FIG. 3 illustrates a flow diagram of a method for developing a positive review trigram model and a negative review trigram model in accordance with implementations of various techniques described herein.

FIG. 4 illustrates a flow diagram of a method for predicting retailer reputations and product reputations in accordance with implementations of various techniques described herein.

FIG. 5 illustrates the determination of the orientation of a review in accordance with implementations of various techniques described herein.

### DETAILED DESCRIPTION

In general, one or more implementations described herein are directed to various techniques for ranking online advertisements using retailer and product reputations. It should be understood that as used herein, the term “retailer” may include a seller or a service provider and the term “product” may include a service. In one implementation, a website may receive a query from a user. The relevance between the query and each advertisement in an advertisement database may be determined. A predicted reputation of the retailer and a predicted reputation of the product associated with each advertisement may be retrieved from a database, e.g., a reputation database or the advertisement database. Other information, such as the click-through rate, the payment per click and the like, may also be retrieved for each advertisement. A ranking score may be calculated for each advertisement based on the advertisement's relevance, predicted retailer reputation, predicted product reputation, and other optional factors. The advertisements may then be ranked and displayed.

In addition, one or more implementations described herein are directed to various techniques for predicting retailer reputation and product reputation. In one implementation, a positive review trigram model and a negative review trigram model may be developed. The trigram models may be developed by collecting online training reviews for various products and retailers. The positive or negative orientation of the training reviews may be manually determined. The reviews determined to be positive reviews may be used to create the positive review trigram model by calculating the probabilities of trigram phrases appearing in the positive reviews. Likewise, the reviews determined to be negative reviews may be used to create the negative review trigram model by calculating the probabilities of trigram phrases appearing in the negative reviews.

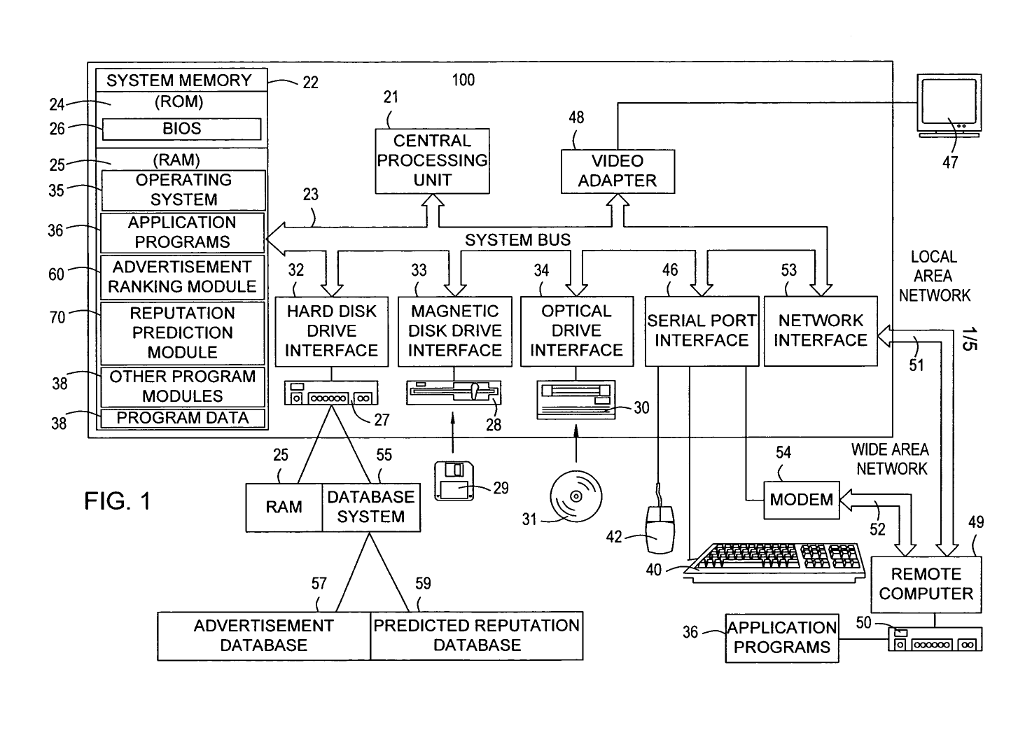

Once the positive review trigram model and the negative review trigram model are developed, retailer reputations and product reputations may be predicted. In one implementation, online reviews for the retailer and product associated with each advertisement may be collected. Each review may be compared to the positive review trigram model and the negative review trigram model to determine the orientation of the review. The predicted reputation of each retailer and the predicted reputation of each product may be calculated by determining the percentage of positive reviews. One or more implementations of various techniques described above will now be described in more detail with reference to FIGS. 1-5 in the following paragraphs.

Implementations of various techniques described herein may be operational with numerous general purpose or special purpose computing system environments or configurations. Examples of well known computing systems, environments, and/or configurations that may be suitable for use with the various techniques described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various techniques described herein may be implemented in the general context of computer-executable instructions, such as program modules, being executed by a computer. Generally, program modules include routines, programs, objects, components, data structures, etc. that perform particular tasks or implement particular abstract data types. The various techniques described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various techniques described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

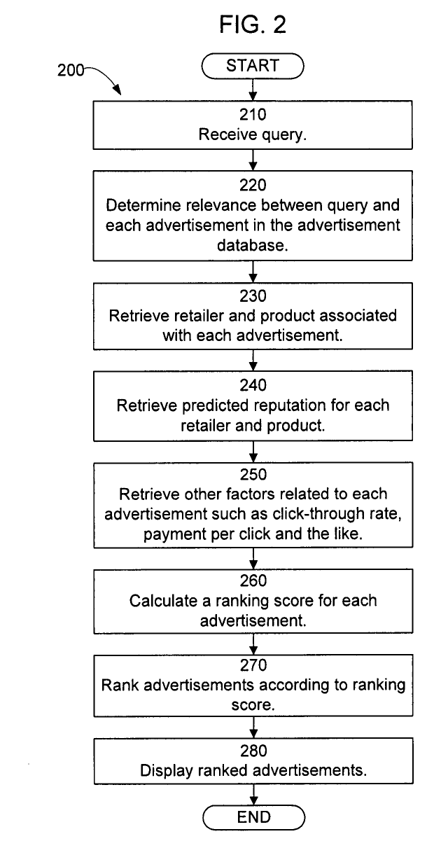

A number of program modules may be stored on the hard disk, magnetic disk 29, optical disk 31, ROM 24 or RAM 25, including an operating system 35, one or more application programs 36, an advertisement ranking module 60, a reputation prediction module 70, program data 38 and a database system 55, which may include an advertisement database 57 and a predicted reputation database 59. The advertisement database 57 and the predicted reputation database 59 may alternatively be stored on a remote computer 49. The operating system 35 may be any suitable operating system that may control the operation of a networked personal or server computer, such as Windows® XP, Mac OS® X, Unix-variants (e.g., Linux® and BSD®), and the like. The advertisement ranking module 60, the reputation prediction module 70, the advertisement database 57, and the predicted reputation database 59 will be described in more detail with reference to FIGS. 2-5 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices, such as speakers and printers.

Further, the computing system 100 may operate in a networked environment using logical connections to one or more remote computers, such as a remote computer 49. The remote computer 49 may be another personal computer, a server, a router, a network PC, a peer device or other common network node. Although the remote computer 49 is illustrated as having only a memory storage device 50, the remote computer 49 may include many or all of the elements described above relative to the computing system 100. The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various techniques described herein may be implemented in connection with hardware, software or a combination of both. Thus, various techniques, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow diagram of a method 200 for ranking online advertisements using predicted retailer reputations and predicted product reputations in accordance with implementations of various techniques described herein. It should be understood that while the operational flow diagram of the method 200 indicates a particular order of execution of the operations, in some implementations, the operations might be executed in a different order.

At step 210, the advertisement ranking module 60 may receive a query from a website that displays advertisements for revenue. The query may be received from a website user. The website may send the query to the advertisement ranking module 60 to determine the advertisements to be displayed. For example, a query for “full size refrigerators” may be received.

At step 220, the relevance between the query and each advertisement in an advertisement database 57 may be determined. The advertisement database 57 may store all advertisements that may be displayed on the website. The advertisement ranking module 60 may determine the level of relevance of each advertisement in the advertisement database 57 to the query received at step 210. The level of relevance may be determined by comparing the query with the text of each advertisement and checking for similarity between them. Continuing with the above example, the advertisement ranking module 60 may determine the level of relevance of each advertisement in the advertisement database 57 to the query, “full size refrigerators”. Advertisements with highly similar text may be determined to have a high level of relevance. For example, advertisement A may have a high level of relevance such as 0.9.

Each advertisement may have a particular retailer and/or product associated with it. As such, at step 230, the retailer and product associated with each advertisement may be retrieved from the advertisement database 57. In one implementation, only the retailer and product associated with advertisements with a level of relevance, determined at step 220, equal to or above a pre-determined level of relevance may be retrieved. Continuing with the above example, the retailer and product associated with each advertisement in the advertisement database 57 may be retrieved. For example, advertisement A may be associated with a particular retailer and a particular refrigerator model. Advertisement B may be associated with a particular retailer and a particular washing machine model. The retailer and product associated with both advertisements may be retrieved. In one implementation, assuming the relevance score of advertisement B to be below a pre-determined level, only the product and retailer for advertisement A may be retrieved.

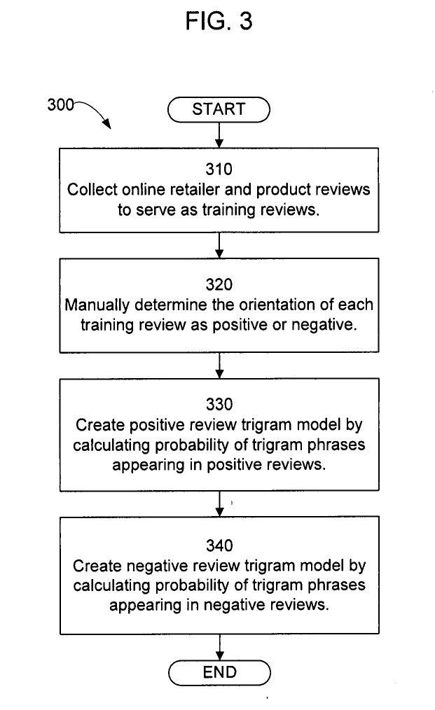

At step 240, a predicted reputation for each retrieved retailer and product may be retrieved from the predicted reputation database 59. In one implementation, the predicted reputation for each retrieved retailer and product may be retrieved from the advertisement database 57. The predicted reputation for each retailer and product may be determined by the reputation prediction module 70 as described in the paragraphs below with reference to FIGS. 3-5. Continuing with the above example, the predicted reputation for the particular retailer associated with advertisement A and the predicted reputation for a particular refrigerator model associated with advertisement A may be retrieved. The predicted reputation for the particular retailer may be 0.7 and the predicted reputation for a particular refrigerator model may be 0.4.

At step 250, other factors related to each advertisement, such as an advertisement's click-through rate, the payment per click and the like, may also be retrieved. In one implementation, the advertisement ranking module 60 may incorporate various factors into the ranking process such as click-through rate, the payment per click and the like. Continuing with the above example, the click-through rate, the payment per click and the like associated with advertisement A may be retrieved.

At step 260, a ranking score for each advertisement may be calculated. In one implementation, factors used to rank the advertisements may be weighted and summed. The ranking score may be calculated using various factors, such as relevance, predicted retailer reputation, predicted product reputation, click-through rate, payment per click, and the like. In one implementation, the ranking score may be calculated using an equation such as the following.

Ranking Score=αRᵣₑₜₐᵢₗₑᵣ+βR_{product}+θRelevance(ad,query) Equation 1

where α, β and θ are the weights associated with each factor, Rᵣₑₜₐᵢₗₑᵣ is the predicted reputation of the retailer associated with the advertisement, R_{product} is the predicted reputation of the product associated with the advertisement, and Relevance(ad,query) is the level of relevance between advertisement ad, and the query, q. Although the ranking score may be calculated using Equation (1), it should be understood that in some implementations the ranking score may be calculated using other equations, including equations that incorporate other factors such as click-through rate, payment per click and the like. Continuing with the above example, a ranking score may be calculated for advertisement A using Equation 1 where α=0.25, β=0.25 and θ=0.5.

Ranking Score=0.25*0.7+0.25*0.4+0.5*0.9=0.725

At step 270, the advertisements may be ranked according to the ranking scores calculated at step 260.

At step 280, the advertisements may be displayed according to the ranking determined at step 270. In this manner, advertisements may be ranked using the predicted reputation of retailers and the predicted reputation of products as well as other factors. Using predicted retailer and product reputations in ranking online advertisements may increase customer clicks on advertisements.

To determine retailer and product reputation, a positive review trigram model and a negative review trigram model may first be developed. FIG. 3 illustrates a flow diagram of a method 300 for developing a positive review trigram model and a negative review trigram model in accordance with implementations of various techniques described herein. It should be understood that while the operational flow diagram of the method 300 indicates a particular order of execution of the operations, in some implementations, the operations might be executed in a different order.

Trigram models may be used to classify reviews as either positive or negative. Each trigram model may model sequences using the statistical properties of trigrams. Trigrams may be defined as subsequences of three items from a given sequence of items. For example, each subsequence of three words in a sentence forms a trigram. In the previous sentence the trigrams may be “for example each”, “example each subsequence” and so on. A trigram model predicts the probability of a word, xᵢ, based on the two previous words, xᵢ₋₁, xᵢ₋₂. The probability of a word, xᵢ, following the words xᵢ₋₁ and xᵢ₋₂ may be determined by calculating the probability in training sequences. Therefore, a positive review trigram model may include a list of probabilities of trigrams that may appear in a positive review. A negative review trigram model may include a list of probabilities of trigrams that may appear in a negative review. It should be noted that not all trigrams that may appear in reviews will correspond to trigrams in the positive review trigram model or the negative review trigram model.

At step 310, online retailer and product reviews may be collected to serve as training reviews. Various websites may gather customer reviews of retailers and products. These websites may be referred to as product information portals. Examples of existing product information portals may be cNet.com®, PriceGrabber.com® and the like. Training reviews, which may include text, may be collected from multiple product information portals. The training reviews may be collected using a web crawler, which may include a program or automated script which browses the World Wide Web in a methodical, automated manner.

At step 320, the orientation of each training review may be manually determined to be either positive or negative. In one implementation, a panel of people may be asked to individually read and assign an orientation of positive or negative to each training review. Each training review may then be classified as either positive or negative based upon the percentage of positive or negative orientation assignments.

At step 330, a positive review trigram model, Mₚ, may be created by calculating the probabilities of trigram phrases appearing in the reviews determined in step 320 to have a positive orientation. The probability P of a trigram phrase (ω₁, ω₂, ω₃) appearing in a text may be determined by the following equation.

$$P ( {ω}_{1} {ω}_{2} {ω}_{3} ) = P ( {ω}_{3} \vert {ω}_{1} {ω}_{2} ) = \frac{\# ( {ω}_{1} {ω}_{2} {ω}_{3} )}{\# ( {ω}_{1} {ω}_{2} )} \qquad Equation 2$$

where #(ω) is the frequency of term series ω. In other words, the probability P of a trigram phrase (ω₁, ω₂, ω₃) appearing in a text may be the number of times the phrase appears in the text divided by the number of times the first two words appear in the text. For example, the number of times the words “I am satisfied” appear in a positive text review divided by the number of times “I am” appears in a positive text review may be calculated to be 0.7. The positive review trigram model, Mₚ, may then include the trigram phrase (I,am,satisfied) with a probability of 0.7.

At step 340, a negative review trigram model may be created by calculating the probabilities of trigram phrases appearing in the reviews determined in step 320 to have a negative orientation. The probability P of each trigram phrase may be determined using Equation 2. Continuing with the above example, the number of times the words “I am satisfied” appear in a negative text review divided by the number of times “I am” appears in a negative text review may be calculated to be 0.1. The negative review trigram model, Mₙ, may then include the trigram phrase (I,am,satisfied) with a probability of 0.1. A probability of the trigram phrase (l,am,not) may also be calculated. As such, the negative review trigram model, Mₙ, may include the trigram phrase (l,am,not) with a probability of 0.8.

In one implementation, a single list of trigram phrases may be selected and the probabilities of the selected trigram phrases may be determined for both the positive review trigram model and the negative review trigram model. In another implementation, the list of trigram phrases may be different for the positive review trigram model and the negative review trigram model. Both the positive review trigram model and the negative review trigram model may be updated to include new trigrams as common language in retailer and product reviews change. In addition, both the positive review trigram model and the negative review trigram model may be updated to keep the probabilities accurate. In yet another implementation, one or more positive review trigram models and/or one or more negative review trigram models may be developed. For example, a positive review trigram model and a negative review trigram model may be developed with trigram phrases specific to an area, such as consumer electronics.

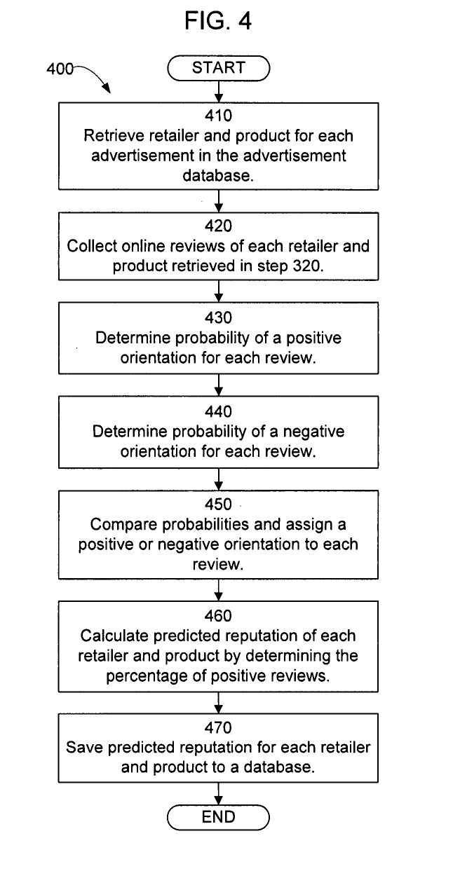

The reputations of retailers and the reputations of products may be predicted using the positive review trigram model and the negative review trigram model. FIG. 4 illustrates a flow diagram of a method 400 for predicting retailer reputations and product reputations in accordance with implementations of various techniques described herein. It should be understood that while the operational flow diagram of the method 400 indicates a particular order of execution of the operations, in some implementations, the operations might be executed in a different order.

At step 410, the reputation prediction module 70 may retrieve the retailer and product associated with each advertisement in the advertisement database.

At step 420, the reputation prediction module 70 may collect online reviews for each retailer and each product associated with each advertisement. Online reviews may be collected from multiple product information portals using a web crawler.

At step 430, the probability of a positive orientation may be determined for each review collected at step 420. To determine the probability of a positive orientation of a review, the text of a review may be compared to the positive review trigram model, Mₚ. Typically, a review may be regarded as a series of terms, w₁w₂ . . . wₖ. For each review, the probability of a positive orientation may be calculated by extracting all the trigram phrases from the review, comparing them to the list of trigram phrases in the positive review trigram model Mₚ and selecting the probabilities from Mₚ for matching trigram phrases. The product of the probabilities for all matching trigram phrases may be the probability of a positive orientation for that review.

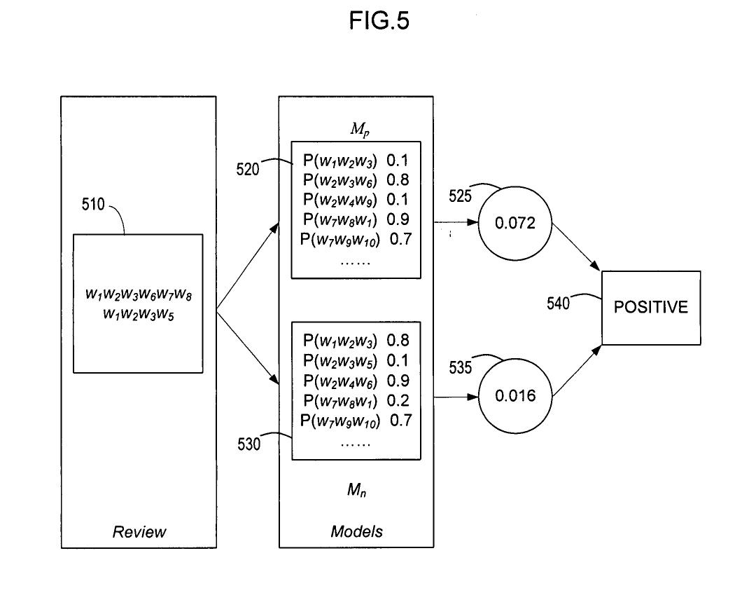

FIG. 5 illustrates the determination of the orientation of a review in accordance with implementations of various techniques described herein. A review 510 may be compared to a positive review trigram model 520. The trigram phrases in the review 510 may be compared to the trigram phrases in the positive trigram model 520. The probabilities in the positive review trigram model 520 for the matching trigram phrases may be multiplied to yield the probability of a positive orientation 525.

At step 440, the probability of a negative orientation may be determined for each review collected at step 420. To determine the probability of a negative orientation of a review, the text of a review may be compared to the negative review trigram model, Mₙ. For each review, the probability of a negative orientation may be calculated by extracting all the trigram phrases from the review, comparing them to the list of trigram phrases in the negative review trigram model Mₙ and selecting the probabilities from Mₙ for matching trigram phrases. The product of the probabilities for all matching trigram phrases may be the probability of a negative orientation for that review.

As illustrated in FIG. 5, a review 510 may be compared to a negative review trigram model 530. The trigram phrases in the review 510 may be compared to the trigram phrases in the negative trigram model 530. The probabilities in the negative review trigram model 530 for the matching trigram phrases may be multiplied to yield the probability of a negative orientation 535.

At step 450, the probability of a positive orientation 525 and the probability of a negative orientation 535 may be compared to assign a predicted orientation to the review. The probability that is higher may be assigned as the predicted orientation. For example, in FIG. 5 the probability of a positive orientation 525 and the probability of a negative orientation 535 may be compared. The probability of a positive orientation 525 is greater than the probability of a negative orientation 535, so the predicted orientation may be assigned to be positive. The following equation may be used to summarize steps 430-450.

$$\begin{matrix}\begin{matrix}{O}_{r} = arg {max}_{i ∈ ( p , n \}} P ( {M}_{i} \vert c ) \\ = arg {max}_{i ∈ \{ p , n )} \frac{P ( {M}_{i} ) P ( c \vert {M}_{i} )}{P ( c )} \\ = arg {max}_{i ∈ ( p , n )} P ( {M}_{i} ) P ( {ω}_{1} {ω}_{2} {ω}_{3} ⋯ {ω}_{k} \vert {M}_{i} ) \\ = arg {max}_{i ∈ \{ p , n )} P ( {M}_{i} ) {\prod }_{j = 3}^{k} P ( {ω}_{k - 2} {ω}_{k - 1} {ω}_{k} \vert {M}_{i} )\end{matrix} & Equation 3\end{matrix}$$

where Oᵣ is the predicted orientation of a review r, i is either positive p or negative n, Mᵢ is the positive review trigram model or the negative review trigram model, c is the review text, P is the probability, and ω is a word.

At step 460, the predicted reputation of each retailer and the predicted reputation of each product may be calculated by determining the percentage of reviews for the retailer or product with positive orientations. For each retailer and product, the number of positive reviews may be divided by the number of collected reviews to determine the percentage of positively oriented reviews. The percentage of positive reviews may be considered the predicted reputation of a retailer or product.

At step 470, the predicted reputation for each retailer and product may be saved in the predicted reputation database 59. In one implementation, the predicted reputation for each retailer and product may be saved in the advertisement database 57. These predicted reputations may be retrieved at step 240 of method 200 for ranking online advertisements using retailer and product reputation.

The method 400 for predicting retailer reputations and product reputations may be repeated frequently to keep the predicted reputations accurate. In addition, the method 400 may be performed for new advertisements as the advertisements are added to the advertisement database 57.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for ranking online advertisements using retailer reputation and product reputation, comprising:
receiving a query;
selecting one or more advertisements based on the query;
retrieving a predicted reputation for a retailer and a predicted reputation for a product associated with each selected advertisement; and
ranking the selected advertisements based on the predicted reputation for the retailer and the predicted reputation of the product.

2. The method of claim 1, wherein ranking the selected advertisements comprises calculating a ranking score for each selected advertisement based on the retailer predicted reputation and the product predicted reputation.

3. The method of claim 2, wherein calculating the ranking score comprises summing weighted factors of the retailer predicted reputation, the product predicted reputation, relevance and other optional factors.

4. The method of claim 1, wherein ranking the selected advertisements comprises calculating a ranking score for each selected advertisement based on the retailer predicted reputation, the product -predicted reputation, relevance and other optional factors.

5. The method of claim 1, wherein the advertisements are selected from an advertisement database.

6. The method of claim 1, wherein retrieving the predicted reputation for the retailer and the predicted reputation for the product comprises retrieving a predicted reputation for each retailer and product associated with each selected advertisement.

7. The method of claim 1, further comprising displaying the ranked advertisements.

8. The method of claim 1, wherein selecting the advertisements comprises:
determining a level of relevance between the query and each advertisement; and
selecting the advertisements having a level of relevance above a pre-determined level of relevance.

9. The method of claim 1, wherein the reputation for the retailer or the reputation for the product associated with each selected advertisement or both is predicted by:
collecting one or more online reviews of the retailer or the product or both that are associated with each selected advertisement;
determining a probability of a positive orientation and a probability of a negative orientation for each online review;
determining an orientation for each online review by comparing the probability of the positive orientation with the probability of the negative orientation; and
calculating the predicted reputation of the retailer or the product or both based on a percentage of online reviews with a positive orientation.

10. The method of claim 9, wherein determining the probability of the positive orientation and the probability of the negative orientation comprises:
determining the probability of the positive orientation for each online review by comparing each online review to a positive review trigram model; and
determining the probability of the negative orientation for each online review by comparing each online review to a negative review trigram model.

11. The method of claim 9, wherein determining the probability of the positive orientation for each online review comprises:
determining one or more trigram phrases in each online review that match one or more trigram phrases in the positive review trigram model;
retrieving a probability for each matching trigram phrase; and
multiplying one or more probabilities for the matching trigram phrases to determine the probability of the positive orientation.

12. The method of claim 9, wherein determining the probability of the negative orientation for each online review comprises:
determining one or more trigram phrases in each online review that match one or more trigram phrases in the negative review trigram model;
retrieving a probability for each matching trigram phrase; and
multiplying one or more probabilities for the matching trigram phrases to determine the probability of the negative orientation.

13. A method for predicting a reputation for a retailer or a product or both, comprising:
collecting one or more online reviews of the retailer or the product or both that are associated with an advertisement;
determining a probability of a positive orientation and a probability of a negative orientation for each online review;
determining an orientation for each online review by comparing the probability of the positive orientation with the probability of the negative orientation; and
calculating the predicted reputation of the retailer or the product or both based on a percentage of online reviews with a positive orientation.

14. The method of claim 13, wherein determining the probability of the positive orientation and the probability of the negative orientation comprises:
determining the probability of the positive orientation for each online review by comparing each online review to a positive review trigram model; and
determining the probability of the negative orientation for each online review by comparing each online review to a negative review trigram model.

15. The method of claim 14, wherein determining the probability of the positive orientation for each online review comprises:
determining one or more trigram phrases in each online review that match one or more trigram phrases in the positive review trigram model;
retrieving a probability for each matching trigram phrase; and
multiplying one or more probabilities for the matching trigram phrases to determine the probability of the positive orientation.

16. The method of claim 14, wherein determining the probability of the negative orientation for each online review comprises:
determining one or more trigram phrases in each online review that match one or more trigram phrases in the negative review trigram model;
retrieving a probability for each matching trigram phrase; and
multiplying one or more probabilities for the matching trigram phrases to determine the probability of the negative orientation.

17. The method of claim 14, wherein the positive review trigram model is developed by:
collecting one or more online reviews for a retailer or product or both as training reviews;
determining an orientation of each training review; and
calculating a probability for each trigram phrase in the training reviews having a positive orientation.

18. The method of claim 14, wherein the negative review trigram model is developed by:
collecting one or more online reviews for a retailer or product or both as training reviews;
determining an orientation of each training review; and
calculating a probability for each trigram phrase in the training reviews having a negative orientation.

19. A computer system, comprising:
a processor; and
a memory comprising program instructions executable by the processor to:
receive a query;
determine a level of relevance between the query and one or more advertisements in a set of advertisements;
select the advertisements having a level of relevance above a pre-determined level of relevance;
retrieve a predicted reputation for a retailer and a predicted reputation for a product associated with each selected advertisement;
calculate a ranking score for each selected advertisement based on the predicted reputation for the retailer and the predicted reputation for the product; and
rank the selected advertisements based on the ranking score.

20. The computer system of claim 19, wherein the memory further comprises program instructions executable by the processor to display the ranked advertisements.
